(19) United States
(12) Patent Application Publication
(10) Pub. No.: US 2007/0257091 A1
(43) Pub. Date: Nov. 8, 2007

(54) Chip Module Having Solder Balls Coated with a Thin Cast Polymer Barrier Layer for Corrosion Protection and Reworkability, and Method for Producing Same

(76) Inventor: Joseph Kuczynski, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/381,781

(22) Filed: May 5, 2006

(51) Int. Cl. B23K 35/12; B23K 1/20

(52) U.S. Cl. 228/246; 228/223; 228/49.1

(57) ABSTRACT

A chip module apparatus includes one or more chips electronically connected to a substrate by controlled collapse chip connection (C4) solder joints. A thin cast polymer barrier layer is cast from solution and covers the C4 solder joints. The chips are enclosed within a cavity that includes a gaseous environment. The cast polymer barrier layer is exposed to, and protects the C4 solder joints from, the cavity's gaseous environment. Accordingly, the cast polymer barrier layer is able to protect the C4 solder joints from corrosion caused by corrosion inducing components (e.g., carbon dioxide, moisture, octanoic acid, etc.) present in the cavity's gaseous environment. To provide reworkability, the cast polymer barrier layer is thermally stable at least to the reflow temperature of the C4 solder joints and has a decomposition temperature below that of the substrate, and preferably has a melting point above the reflow temperature of the C4 solder joints.

### BACKGROUND OF THE INVENTION

1. Field of Invention

The present invention relates in general to the field of electronic packaging. More particularly, the present invention relates to electronic packaging that provides corrosion protection and reworkability for the solder balls of a flip-chip module by coating the solder balls with a thin cast polymer barrier layer.

2. Background Art

Electronic components, such as microprocessors and integrated circuits, are generally packaged using electronic packages (i.e., modules) that include a module substrate to which one or more electronic component(s) is/are electronically connected. A single-chip module (SCM) contains a single electronic component such as a central processor unit (CPU), memory, application-specific integrated circuit (ASIC) or other integrated circuit. A multi-chip module (MCM), on the other hand, contains two or more such electronic components.

Generally, each of these electronic components takes the form of a flip-chip, which is a semiconductor chip or die having an array of spaced-apart terminals or pads on its base to provide base-down mounting of the flip-chip to the module substrate. The module substrate is typically a ceramic carrier or other conductor-carrying substrate.

Controlled collapse chip connection (C4) solder joints (also referred to as “solder bumps”) are typically used to electrically connect the terminals or pads on the base of the flip-chip with corresponding terminals or pads on the module substrate. C4 solder joints are disposed on the base of the flip-chip in an array of minute solder balls (e.g., on the order of 100 μm diameter and 200 μm pitch). The solder balls, which are typically lead (Pb)-containing solder, are reflowed to join (i.e., electrically and mechanically) the terminals or pads on the base of the flip-chip with corresponding terminals or pads on the module substrate.

Typically, a non-conductive polymer underfill is disposed in the space between the base of the flip-chip and the module substrate and encapsulates the C4 solder joints. The C4 solder joints are embedded in this polymeric underfill and are thus protected from corrosion caused by moisture and carbon dioxide in the air, as well as octanoic acid outgassed from components within the module. However, as discussed below, the use of the polymeric chip underfill disadvantageously renders the assembled flip-chip(s)/module substrate un-reworkable.

FIG. 1 illustrates an example of a conventional multi-chip module assembly 100 that utilizes C4 solder joints and a polymeric chip underfill. FIG. 2 is an enlarged view of the C4 solder joints and the polymeric chip underfill of the conventional multi-chip module assembly 100. In many computer and other electronic circuit structures, an electronic module is electrically connected to a printed circuit board (PCB). For example, the conventional multi-chip module assembly 100 shown in FIGS. 1 and 2 includes capped module 105 electrically connected to a PCB 110. Generally, in connecting an electronic module to a PCB, a plurality of individual electrical contacts on the base of the electronic module must be connected to a plurality of corresponding individual electrical contacts on the PCB. Various technologies well known in the art are used to electrically connect the set of contacts on the PCB and the electronic module contacts. These technologies include land grid array (LGA), ball grid array (BGA), column grid array (CGA), pin grid array (PGA), and the like. In the illustrative example shown in FIG. 1, a LGA 115 electrically connects PCB 110 to a module substrate 120. LGA 115 may comprise, for example, conductive elements 116, such as fuzz buttons, retained in a non-conductive interposer 117.

In some cases, the module includes a cap (i.e., a capped module) which seals the electronic component(s) within the module. The module 105 shown in FIG. 1 is a capped module. In other cases, the module does not include a cap (i.e., a bare die module). In the case of a capped module, a heat sink is typically attached with a thermal interface between a bottom surface of the heat sink and a top surface of the cap, and another thermal interface between a bottom surface of the cap and a top surface of the electronic component(s). For example, as shown in FIG. 1, a heat sink 150 is attached with a thermal interface 155 between a bottom surface of heat sink 150 and a top surface of a cap 160, and another thermal interface 165 between a bottom surface of cap 160 and a top surface of each flip-chip 170. In addition, a heat spreader (not shown) may be attached to the top surface of each flip-chip 170 to expand the surface area of thermal interface 165 relative to the surface area of the flip-chip 170. The heat spreader, which is typically made of a highly thermally conductive material such as SiC, is typically adhered to the top surface of the flip-chip 170 with a thermally-conductive adhesive. Typically, a sealant 166 (e.g., a silicone adhesive such as Sylgard 577) is applied between cap 160 and module substrate 120 to seal the chip cavity 167. In the case of a bare die module, a heat sink is typically attached with a thermal interface between a bottom surface of the heat sink and a top surface of the electronic component(s). Heat sinks are attached to modules using a variety of attachment mechanisms, such as adhesives, clips, clamps, screws, bolts, barbed push-pins, load posts, and the like.

Capped module 105 includes a module substrate 120, a plurality of flip-chips 170, LGA 115, and cap 160. In addition, capped module 105 includes C4 solder joints 175 electrically connecting each flip-chip 170 to module substrate 120. As best seen in FIG. 2, capped module 110 also includes a non-conductive polymer underfill 180 which is disposed in the space between the base of each flip-chip 170 and module substrate 120 and encapsulates the C4 solder joints 175. C4 solder joints 175 are embedded in polymeric underfill 180 and, thus, as mentioned above, are protected from moisture and carbon dioxide in the air, as well as octanoic acid outgassed from components within chip cavity 167. Without polymeric chip underfill 180, the solder balls of C4 solder joints 175 would corrode, and electrically short neighboring solder balls. Atmospheric carbon dioxide is the primary factor controlling corrosion of the Pb-containing solder balls of C4 solder joints 175, presumably through a series of reaction steps known as the “Dutch reaction”. Another major contributor to solder corrosion is octanoic acid outgassing from the thermal grease typically used to provide thermal interface 165.

As noted above, carbon dioxide is the primary factor controlling solder corrosion. This source of corrosion presumably occurs through the Dutch reaction, which is initiated by the oxidation of lead in the presence of O₂ and H₂O to form lead hydroxide. Lead hydroxide and acetic acid react in two steps to form basic lead acetate. Decomposition of basic lead acetate by CO₂ regenerates lead acetate and H₂O so the reaction can proceed again. The reaction is autocatalytic as long as O₂ and CO₂ are available. Over time, CO₂, O₂ and moisture seep into chip cavity 167 (e.g., through sealant 166) and, consequently, corrode the Pb-containing solder balls of C4 solder joints 175.

Also as noted above, octanoic acid is another major contributor to solder corrosion. Octanoic acid outgases from the thermal grease that is typically used to provide thermal interface 165. Thermal grease, in the form of a thin layer of advanced thermal compound (ATC), is typically used to provide thermal interface 165, i.e., the thermal grease fills the gap between a bottom surface of cap 160 and a top surface of each flip-chip 170. The proximity of the thermal grease to the Pb-containing solder balls of C4 solder joints 175 allows octanoic acid to readily condense on and, consequently, corrode the solder balls.

Polymeric chip underfill 180 protects C4 solder joints 175 from both of the corrosion mechanisms described above but, unfortunately, traditional formulations of underfill 180 render the assembled flip-chips 170/module substrate 120 un-reworkable. Typically, the formulation of polymeric chip underfill 180 is a thermoset of crosslinked epoxy materials that are intractable and extremely thermally stable. Generally, it is preferable to use technologies that provide reworkability. However, the use of polymeric chip underfill 180 having traditional formulations stands as an obstacle to reworkablility and, thus, increases the cost of manufacturing and maintenance.

It is also known to use silicon nitride (Si₃N₄) to seal a flip-chip. For example, U.S. Pat. No. 6,972,249 B2, entitled “Use of Nitrides for Flip-Chip Encapulation” and issued Dec. 6, 2005 to Akram et al., discloses a semiconductor flip-chip that is sealed with a silicon nitride layer on an active surface of the flip-chip. The silicon nitride layer covers the chip active surface, including the bond pads and conductive connectors such as solder balls formed over the bond pads. Unfortunately, like traditional formulations for polymeric chip underfill 180, the silicon nitride layer renders the assembly unreworkable.

Several approaches have been proposed to simultaneously address the issue of C4 solder joint corrosion as well as the desire to provide reworkability. In one approach, a reworkable polymeric chip underfill is provided. Reworkable polymeric chip underfills are crosslinked networks (typically epoxy-based) that can be removed either via solvolysis (reaction following dissolution in a suitable solvent) or thermolysis (elevated temperature cleavage of crosslinks). For example, U.S. Pat. No. 5,560,934, entitled “Cleavable Diepoxide for Removable Epoxy Compositions” and issued on Oct. 1, 1996 to Afzali-Ardakani et al., discloses a cleavable epoxy resin composition suitable for encapsulating electronic chips. Although solvolysis has been shown to function with respect to reworkable encapsulants, solvolysis has not proven to be effective in underfill applications because the process is difficult and time consuming. Likewise, the temperatures and residue resulting from thermolysis are unacceptable.

In a second approach as disclosed in U.S. Pat. No. 5,274,913, entitled “Method of Fabricating a Reworkable Module” and issued on Jan. 4, 1994 to Grebe et al., a passivating layer of parylene is used in conjunction with an epoxide layer that may be removed with a depotting solution. The parylene is vapor deposited and polymerized on the package, between the substrate and the integrated circuit chip, encapsulating the C4 connections. Then the substrate and the chip are encapsulated by the epoxide layer. The parylene passivating layer is capable of acting as a release agent between the integrated circuit chip and the card or board. The epoxide layer may be removed by the depotting solution without effecting the packaging materials (e.g., polymeric organic substrate materials and Cu) since they are protected by the parylene coating. Unfortunately, removal of the epoxide using a depotting solution is a difficult and time consuming process.

Therefore, a need exists for an enhanced method and apparatus for protecting solder joints from corrosion caused by carbon dioxide, moisture, and octanoic acid within the chip cavity of a chip module.

### SUMMARY OF THE INVENTION

According to the preferred embodiments of the present invention, a chip module apparatus includes one or more chips electronically connected to a substrate by controlled collapse chip connection (C4) solder joints. A thin cast polymer barrier layer is cast from solution and covers the C4 solder joints. The one or more chips are enclosed within a cavity that includes a gaseous environment. The cast polymer barrier layer is exposed to, and protects the C4 solder joints from, the cavity's gaseous environment. Accordingly, the cast polymer barrier layer is able to protect the C4 solder joints from corrosion caused by corrosion inducing components (e.g., carbon dioxide, moisture, octanoic acid, etc.) present in the cavity's gaseous environment. To provide reworkability, the cast polymer barrier layer is thermally stable at least to the reflow temperature of the C4 solder joints and has a decomposition temperature below that of the substrate, and preferably has a melting point above the reflow temperature of the C4 solder joints.

### BRIEF DESCRIPTION OF THE DRAWINGS

The preferred exemplary embodiments of the present invention will hereinafter be described in conjunction with the appended drawings, where like designations denote like elements.

FIG. 1 is a sectional view of a conventional multi-chip module assembly that utilizes C4 solder joints and a polymeric chip underfill.

FIG. 2 is an enlarged sectional view of the C4 solder joints and the polymeric chip underfill of the conventional multi-chip module assembly shown in FIG. 1.

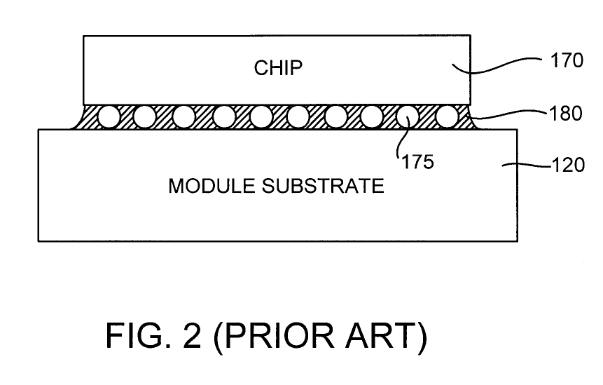

FIG. 3 is a sectional view of a multi-chip module assembly that utilizes C4 solder joints covered with a thin cast polymer barrier layer according to the preferred embodiments of the present invention.

FIG. 4 is an enlarged sectional view of the C4 solder joints and the thin cast polymer barrier layer of the multi-chip module assembly shown in FIG. 3.

FIG. 5 is a flow chart diagram of a method for producing a multi-chip module assembly that utilizes C4 solder joints covered with a thin cast polymer barrier layer according to the preferred embodiments of the present invention.

FIG. 6 is a flow chart diagram of a method for reworking a multi-chip module assembly that utilizes C4 solder joints covered with a thin cast polymer barrier layer according to the preferred embodiments of the present invention.

### DETAILED DESCRIPTION OF THE PREFERRED EMBODIMENTS

1. Overview

In accordance with the preferred embodiments of the present invention, a chip module apparatus includes one or more chips electronically connected to a substrate by controlled collapse chip connection (C4) solder joints. A thin cast polymer barrier layer is cast from solution and covers the C4 solder joints. The one or more chips are enclosed within a cavity that includes a gaseous environment. The cast polymer barrier layer is exposed to, and protects the C4 solder joints from, the cavity's gaseous environment. Accordingly, the cast polymer barrier layer is able to protect the C4 solder joints from corrosion caused by corrosion inducing components (e.g., carbon dioxide, moisture, octanoic acid, etc.) present in the cavity's gaseous environment. To provide reworkability, the cast polymer barrier layer is thermally stable at least to the reflow temperature of the C4 solder joints and has a decomposition temperature below that of the substrate, and preferably has a melting point above the reflow temperature of the C4 solder joints.

2. Detailed Description

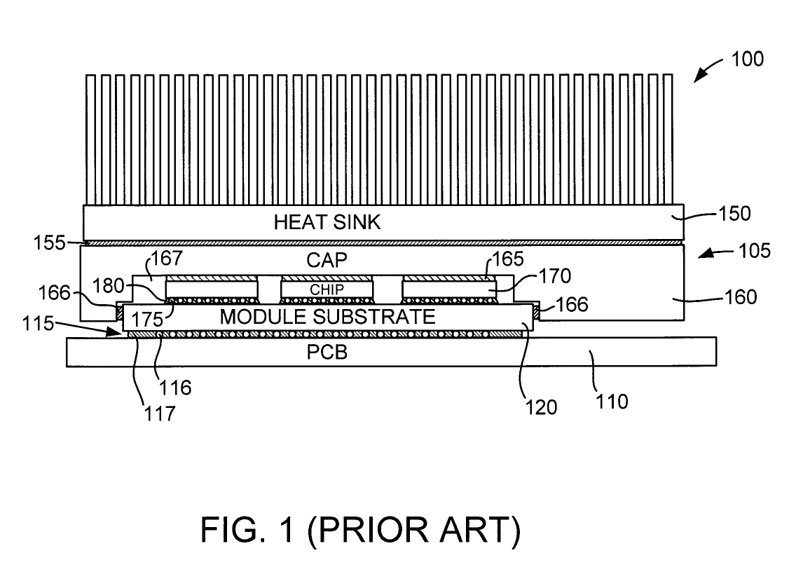

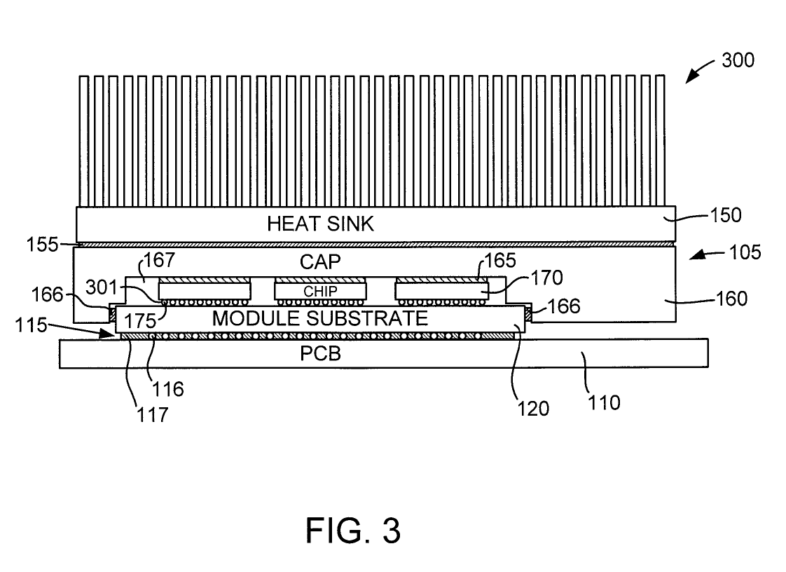

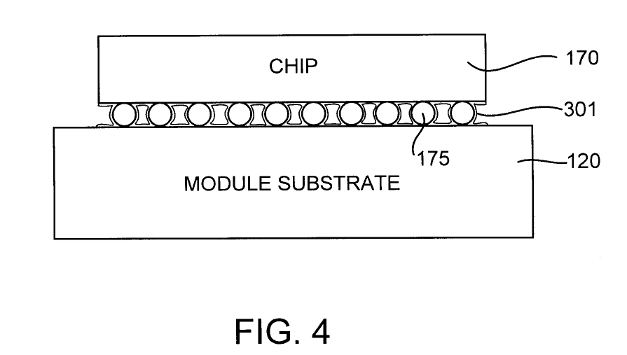

Referring now to FIG. 3, there is depicted, in a sectional view, a multi-chip module assembly 300 that utilizes C4 solder joints covered with a thin cast polymer barrier layer according to the preferred embodiments of the present invention. The multi-chip module assembly 300 shown in FIG. 3 is similar to the conventional multi-chip module assembly 100 shown in FIG. 1, but the polymeric chip underfill 180 shown in FIG. 1 is replaced in FIG. 3 with a thin cast polymer barrier layer 301 (best seen in FIG. 4) according to the preferred embodiments of the present invention. FIG. 4 illustrates, in an enlarged sectional view, the thin cast polymer barrier layer 301 that cover C4 solder joints 175 of the multi-chip module assembly shown in FIG. 3.

The multi-chip module assembly shown in FIG. 3 is exemplary. Those skilled in the art will appreciate that the methods and apparatus of the present invention can also apply to configurations differing from the multi-chip module assembly shown in FIG. 3 and apply to other types of chip modules. For example, in lieu of being applied to a capped module, such as capped module 105 shown in FIG. 3, the methods and apparatus of the present invention can also be applied to a bare die module.

Some of the elements of multi-chip module assembly 300 shown in FIG. 3 are identical to those discussed above with respect to the conventional multi-chip module assembly 100 shown in FIG. 1. Those identical elements are discussed briefly again below, along with a detailed discussion of elements unique to the present invention.

Multi-chip module assembly 300 includes a capped module 105 electrically connected to a PCB 110. Generally, as mentioned earlier, in connecting an electronic module to a PCB, a plurality of individual electrical contacts on the base of the electronic module must be connected to a plurality of corresponding individual electrical contacts on the PCB. Various technologies well known in the art are used to electrically connect the set of contacts on the PCB and the electronic module contacts. These technologies include land grid array (LGA), ball grid array (BGA), column grid array (CGA), pin grid array (PGA), and the like. In the illustrative example shown in FIG. 3, a LGA 115 electrically connects PCB 110 to a module substrate 120. LGA 115 may comprise, for example, conductive elements 116, such as fuzz buttons, retained in a non-conductive interposer 117. One skilled in the art will appreciate, however, that any of the various other technologies may be used in lieu of, or in addition to, such LGA technology.

Preferably, as shown in FIG. 3, module 105 includes a cap 160 (i.e., module 105 is a “capped module”). In the case of a capped module, a heat sink is typically attached with a thermal interface between a bottom surface of the heat sink and a top surface of the cap, and another thermal interface between a bottom surface of the cap and a top surface of the electronic component(s). For example, as shown in FIG. 3, a heat sink 150 is attached with a thermal interface 155 between a bottom surface of heat sink 150 and a top surface of a cap 160, and another thermal interface 165 between a bottom surface of cap 160 and a top surface of each flip-chip 170. In addition, a heat spreader (not shown) may be attached to the top surface of each flip-chip 170 to expand the surface area of thermal interface 165 relative to the surface area of the flip-chip 170. The heat spreader, which is typically made of a highly thermally conductive material such as SiC, is typically adhered to the top surface of the flip-chip 170 with a thermally-conductive adhesive. Typically, a sealant 166 (e.g., a silicone adhesive such as Sylgard 577) is applied between cap 160 and module substrate 120 to seal the chip cavity 167.

Heat sink 150 is attached to module 105 using a thermally-conductive adhesive to form thermal interface 155. Although not shown for the sake of clarity, heat sink 150 is also attached to module 105 through a conventional LGA mounting mechanism. In this regard, heat sink 150 includes a plurality of bolts or load posts (not shown) that project from the bottom surface of heat sink 150. Typically, one bolt or load post is positioned on each side of the generally square or rectangular footprint of module cavity 167. The bolts or load posts pass through correspondingly positioned throughholes (not shown) in cap 160, PCB 110 and an insulated steel backup plate (not shown). As is well known in the art, the bolts or load posts cooperate with one or more compression springs (not shown) to urge assembly 300 together with force sufficient to make the electrical connections of LGA 115. Alternatively, those skilled in the art will recognize that other attachment mechanisms may be used. Generally, heat sinks, PCBs and the like, are attached to modules using a variety of attachment mechanisms, such as adhesives, clips, clamps, screws, bolts, barbed push-pins, load posts, and the like.

As mentioned above, the module may alternatively be a “bare die module” that does not include a cap. In this “bare die module” alternative case, a heat sink is attached with a thermal interface between a bottom surface of the heat sink and a top surface of each flip-chip. In addition, a heat spreader may be attached to the top surface of each flip-chip to expand the surface area of the thermal interface relative to the surface area of the flip-chip. In the “bare die module” alternative case, a non-conductive spacer frame extends between a bottom surface of the heat sink and the top surface of the PCB. Rather than being defined by surfaces of the cap, the module cavity in this alternative case would be defined by surfaces of the non-conductive spacer frame and the heat sink. Also, in the “bare die module” alternative case a butyl rubber gasket may be seated along the periphery of the non-conductive spacer frame to seal the electronic component(s) within the module cavity.

Module 105 includes C4 solder joints 175 electrically connecting each flip-chip 170 to module substrate 120. Unlike conventional multi-chip module assembly 100 shown in FIG. 1, multi-chip module assembly 300 in accordance with the preferred embodiments of the present invention does not utilize a polymeric chip underfill to protect C4 solder joints 175 from corrosion. Omitting this element is advantageous because the polymeric chip underfill renders the assembled flip-chips 170/module substrate 120 un-reworkable. The polymeric chip underfill is used in the prior art to prevent the solder balls of C4 solder joints 175 from corroding and electrically shorting neighboring solder balls.

Atmospheric carbon dioxide is the primary factor controlling corrosion of the Pb-containing solder balls of C4 solder joints 175, presumably through a series of reaction steps known as the “Dutch reaction”. The Dutch reaction is initiated by the oxidation of lead in the presence of O₂ and H₂O to form lead hydroxide. Lead hydroxide and acetic acid react in two steps to form basic lead acetate. Decomposition of basic lead acetate by CO₂ regenerates lead acetate and H₂O so the reaction can proceed again. The reaction is autocatalytic as long as O₂ and CO₂ are available. Over time, CO₂, O₂ and moisture seep into chip cavity 167 (e.g., through sealant 166) and, consequently, if left unaddressed can corrode the Pb-containing solder balls of C4 solder joints 175.

Octanoic acid is another major contributor to solder corrosion. Octanoic acid outgases from the thermal grease that is typically used to provide thermal interface 165. Thermal grease, in the form of a thin layer of advanced thermal compound (ATC), is typically used to provide thermal interface 165, i.e., the thermal grease fills the gap between a bottom surface of cap 160 and a top surface of each flip-chip 170. The proximity of the thermal grease to the Pb-containing solder balls of C4 solder joints 175 allows octanoic acid to readily condense on and, consequently, if left unaddressed can corrode the Pb-containing solder balls of C4 solder joints 175.

In accordance with the preferred embodiments of the present invention, thin cast polymer barrier layer 301 protects the C4 solder joints 175 from both of the corrosion mechanisms described above. A thin cast polymer barrier layer in accordance with the preferred embodiments provides corrosion protection yet still enables the chip module to be reworked. A thin cast polymer barrier layer in accordance with the preferred embodiments of the present invention does not stand as an obstacle to reworkability because, as discussed in detail below, the thin cast polymer barrier layer is easily removed at elevated temperature.

The thin cast polymer barrier layer according to the preferred embodiments of the present invention is cast from a dilute polymer solution, i.e., a polymer in a solvent. The dilute polymer solution is permitted to contact the solder balls by wicking between the chip and the module substrate. The solvent may then be driven off leaving behind a thin layer of cast polymer on the solder balls, and as well as on the base of the chip and the module substrate. Since the thin cast polymer barrier layer is organic, the electrical integrity of the solder connections is not compromised.

Generally, process restrictions limit the selection of suitable polymers that may be solution cast. Examples of such restrictions include the toxicity of the solvent, the ease with which the solvent may be removed, and the thermal stability of the polymer. Regarding thermal stability, the polymer must not degrade unacceptably at temperatures below the solder reflow temperature (e.g., 215-240° C.). In other words, the thin cast polymer barrier layer according to the preferred embodiments of the present invention will be thermally stable at least to the solder reflow temperature. In addition, the polymer must have a decomposition temperature below the decomposition temperature of the substrate, i.e., the temperature at which the substrate suffers unacceptable degradation. This allows the thin cast polymer barrier layer according to the preferred embodiments of the present invention to be removed through thermal decomposition without adversely impacting the substrate. Preferably, the polymer will possess a melting temperature above the solder reflow temperature in order to avoid potential thinning of the thin cast polymer barrier layer of solder balls as neighboring sites undergo rework.

With these limitations in mind, the following are representative examples of suitable polymers: polystyrene; poly(oxymethyleneoxyethylene); poly(oxybutylethylene); poly(vinylidene chloride); poly(perfluoro-4-chloro-1,6-heptadiene); poly(methacrylic acid), ethyl ester; poly(methacrylic acid), n-propyl ester; poly(methacrylic acid), i-propyl ester; poly(methacrylic acid), n-butyl ester; poly(methacrylic acid), i-butyl ester; poly(methacrylic acid), sec-butyl ester; poly(methacrylic acid), n-amyl ester; poly(methacrylic acid), i-amyl ester; poly(methacrylic acid), 1,2-dimethylpropyl ester; poly(methacrylic acid), neopentyl ester; poly(methacrylic acid), 3,3-dimethylbutyl ester; poly(methacrylic acid), 1,3-dimethylbutyl ester; poly(perfluoropropylene); poly(vinyl alcohol); poly(vinyl butyrate); poly(methyl isopropenyl ketone); and combinations thereof. This list of suitable polymers is exemplary, and those skilled in the art will appreciate that other polymers are suitable within the spirit and scope of the present invention.

Solubility of the polymer in a solvent can be predicted from Hansen solubility parameters and the adage that “like dissolves like”, i.e., non-polar solvents will dissolve non-polar polymers, while polar solvents will dissolve polar polymers. For example, polystyrene is soluble in aromatic hydrocarbons (e.g., toluene and xylene), chlorinated hydrocarbons (e.g., methylene chloride and carbon tetrachloride), and cyclohexane. This is not an exhaustive list, and those skilled in the art will appreciate that other suitable solvents exist for polystyrene and are within the spirit and scope of the present invention. In general, suitable solvents include, but are not limited to, one or more of toluene, xylene, cyclohexane, nitrobenzene, dioxane, methyl ethyl ketone, glycols, glycerol, alcohols, tetrahydrofuran, and the like.

Table 1 below lists several exemplary polymer/solvent combinations that may be used to provide a suitable polymer solution in accordance with the preferred embodiments of the present invention. Each polymer is listed with one or more solvents suitable for use with that particular polymer, the polymer's melting point, and the polymer's decomposition temperature (as published in the Polymer Handbook, 2nd Edition, 1975). The polymer/solvent combinations listed in Table 1 are exemplary, and those skilled in the art will appreciate that other polymer/solvent combinations may be used within the spirit and scope of the present invention.

TABLE 1

| | | Melting | Decomposition |
|---|---|---|---|
| Polymer | Solvent(s) | Point (C.) | Temperature (C.) |
| Polystyrene | Toluene, xylene, | 240-250 | 300-400 (decomposed to |
| | cyclohexane | | monomer oligomers) |
| Poly(oxymethyleneoxyethylene) | — | NA | 314-338 (decomposed to |
| | | | gaseous products) |
| Poly(oxybutylethylene) | — | NA | 321-365 (decomposed to |
| | | | gaseous products) |
| Poly(vinylidene chloride) | Nitrobenzene | 76 | 225-275 (decomposed to |
| | | | HCl primarily) |
| Poly(perfluoro-4-chloro-1,6- | — | NA | 320-400 (completely |
| heptadiene) | | | volatilized) |
| Poly(methacrylic acid), ethyl ester | Toluene, xylene, | NA | 250 (decomposed to |
| | dioxane, MEK | | monomer) |
| Poly(methacrylic acid), n-propyl | Toluene, xylene, | NA | 250 (decomposed to |
| ester | dioxane, MEK | | monomer) |
| Poly(methacrylic acid), i-propyl | Toluene, xylene, | NA | 250 (decomposed to |
| ester | dioxane, MEK | | monomer) |
| Poly(methacrylic acid), n-butyl | Toluene, xylene, | NA | 250 (decomposed to |
| ester | dioxane, MEK | | monomer and 1-butene) |
| Poly(methacrylic acid), i-butyl | Toluene, xylene, | NA | 250 (decomposed to |
| ester | dioxane, MEK | | monomer) |
| Poly(methacrylic acid), sec-butyl | Toluene, xylene, | NA | 250 (decomposed to |
| ester | dioxane, MEK | | monomer and olefin) |
| Poly(methacrylic acid), n-amyl | Toluene, xylene, | NA | 250 (decomposed to |
| ester | dioxane, MEK | | monomer) |
| Poly(methacrylic acid), i-amyl | Toluene, xylene, | NA | 250 (decomposed to |
| ester | dioxane, MEK | | monomer) |
| Poly(methacrylic acid), 1,2- | Toluene, xylene, | NA | 250 (decomposed to |
| dimethylpropyl ester | dioxane, MEK | | monomer and olefin) |
| Poly(methacrylic acid), neopentyl | Toluene, xylene, | NA | 250 (decomposed to |
| ester | dioxane, MEK | | monomer) |
| Poly(methacrylic acid), 3,3- | Toluene, xylene, | NA | 250 (decomposed to |
| dimethylbutyl ester | dioxane, MEK | | monomer) |
| Poly(methacrylic acid), 1,3- | Toluene, xylene, | NA | 250 (decomposed to |
| dimethylbutyl ester | dioxane, MEK | | monomer and olefin) |
| Poly(perflouropropylene) | — | NA | 280-400 (decomposed to |
| | | | monomer) |
| Poly(vinyl alcohol) | Hot glycols, | 200 | 250 (decomposed to |
| | glycerol, water | | water) |
| Poly(vinyl butyrate) | Alcohols | 130 | 300-325 (decomposed to |
| | | | butyric acid) |
| Poly(methyl isopropenyl ketone) | THF, dioxane | NA | 270-360 (decomposed to |
| | | | water) |

The polymer concentration in the polymer solution is preferably very dilute (i.e., preferably less than or equal to about 1 wt %) so that the viscosity of the polymer solution does not increase to the point where it is difficult to wick into the gap between the base of the chip and the module substrate. Dilute polymer solutions are also preferred because once the solvent is driven off, the resulting thin polymer barrier layer that covers the solder balls need be no greater than about one micron thick in order to sufficiently limit diffusion of corrosive gases.

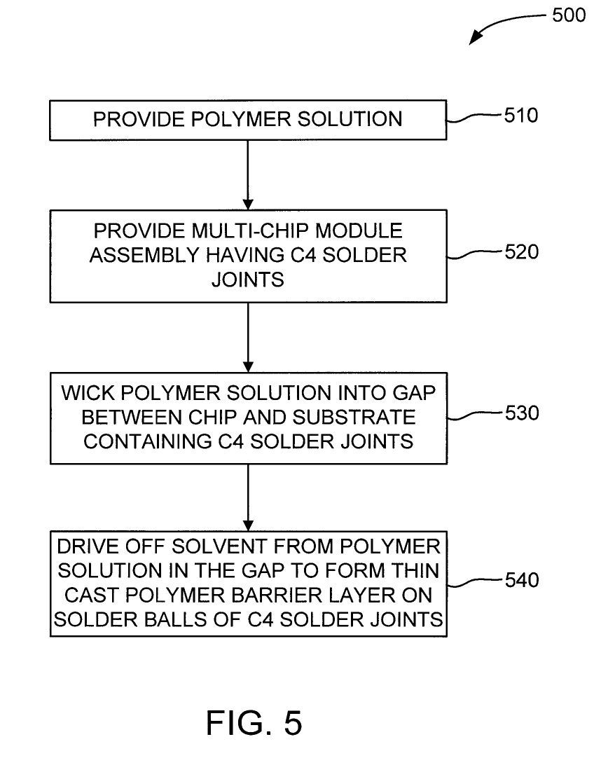

FIG. 5 illustrates, in a flow chart diagram, a method 500 for producing a multi-chip module assembly that utilizes C4 solder joints covered with a thin cast polymer barrier layer according to the preferred embodiments of the present invention. Method 500 sets forth the preferred order of steps. It must be understood, however, that the various steps may occur simultaneously or at other times relative to one another. Method 500 begins by providing a polymer solution by dissolving the selected polymer in an appropriate solvent (step 510). For example, the polymer solution may consist of 1 wt % polystyrene in cyclohexane, or 1 wt % PVA in hot water. Method 500 continues by providing a multi-chip module assembly comprising a plurality of chips electrically connected to a substrate by C4 solder joints (step 520). The polymer solution is dispensed around the solder balls of the C4 solder joints of at least one of the chips by wicking the polymer solution into the gap between the base of the chip and the substrate (step 530). Preferably, the polymer solution is dispensed from a syringe in contact with the periphery of the chip and surface tension wicks the solution into the gap and around the solder balls. Then, the solvent in the gap is driven off to form the thin cast polymer barrier layer on the solder balls (step 540). The thin cast polymer barrier layer will also form on other surfaces within the gap, i.e., on the base of the chip and the substrate. Generally, the process parameters used to drive off the solvent will vary based on the particular solvent used. For example, in the case of low boiling point solvents such as cyclohexane, an oven bake at 100° C. for 10 min will typically be sufficient. In the case of higher boiling point solvents such as toluene, an oven bake at 125° C. or a vacuum oven bake at 100° C. and reduced pressure (e.g., about 500 m torr) for 10 min will typically be sufficient. The resulting thin cast polymer barrier layer now protects the solder balls from corrosion-inducing gases.

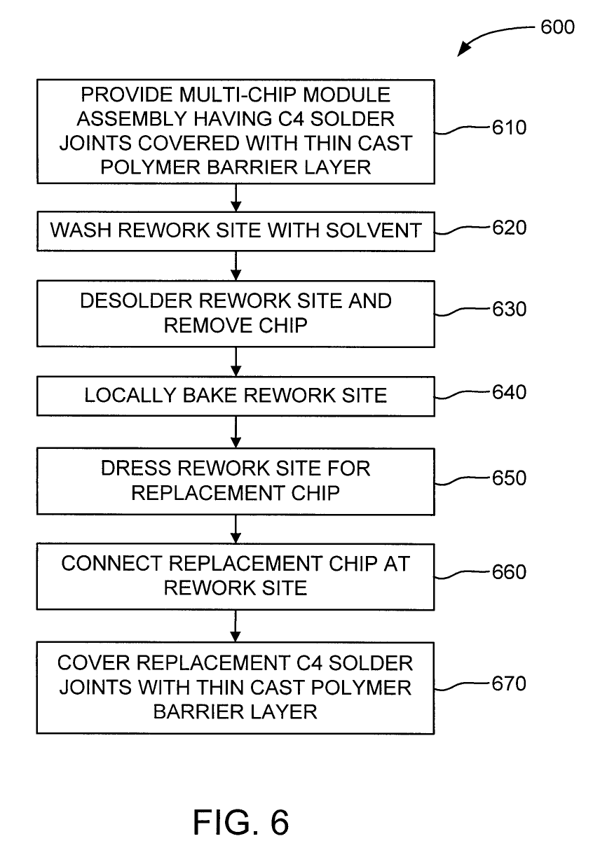

FIG. 6 illustrates, in a flow chart diagram, a method 600 for reworking a multi-chip module assembly that utilizes C4 solder joints covered with a thin cast polymer barrier layer according to the preferred embodiments of the present invention. Method 600 sets forth the preferred order of steps. It must be understood, however, that the various steps may occur simultaneously or at other times relative to one another. Method 600 begins by providing a multi-chip module assembly having solder joints covered with a thin cast polymer barrier layer (step 610). The multi-chip module assembly has one or more chip sites that need to be reworked. Method 600 continues with an optional step of washing the rework site with an appropriate solvent (step 620). This step is considered optional because the elevated temperature of the subsequent desoldering step preferably melts or at least partially decomposes the thin cast polymer barrier layer. This optional step may be desirable to reduce the thickness and integrity of the thin cast polymer barrier layer to increase the efficiency of the removal steps that follow. An appropriate solvent in selected based on the composition of the thin cast polymer barrier layer. For example, cyclohexane may be used if the thin cast polymer barrier layer is polystyrene, while hot water may be used if the thin cast polymer barrier layer is PVA. Next, the rework site is desoldered and the chip removed using conventional techniques well known in the art (step 630). For example, a reflow tool may be used to desolder the C4 solder joints or, alternatively, a desoldering iron may be used for hand rework. In either case, the elevated temperature of the reflow tool or desoldering iron preferably melts or at least partially decomposes the thin cast polymer layer covering the C4 solder joints. The chip is removed from the rework site while C4 solder joints are in a reflowed state using, for example, a gripper fixture or other mechanism well known to those skilled in the art. Method 600 continues by locally baking the multi-chip module assembly at the rework site using a bake temperature at or above the decomposition temperature of the thin cast polymer barrier layer (step 640). The rework site may be locally baked by directional air flow or other techniques known to those skilled in the art. Then, the rework site is dressed for a replacement chip (step 650). For example, as is well known to those skilled in the art, a tinned sintered porous Cu block may be used to soak up the residual solder during furnace Cu block dressing to avoid solder build up after one or more chip rework cycles. Once the rework site is dressed, a replacement chip is connected to the substrate at the rework site using replacement C4 solder joints by applying techniques well known to those skilled in the art (step 660). The replacement C4 solder joints are then covered with a replacement thin cast polymer barrier layer (step 670). This may be accomplished using the steps of the above-described method 500.

One skilled in the art will appreciate that many variations are possible within the scope of the present invention. For example, the methods and apparatus of the present invention can also apply to configurations differing from the multi-chip module assembly shown in FIG. 3 and apply to other types of chip modules. For example, in lieu of being applied to a capped module, such as capped module 105 shown in FIG. 3, the methods and apparatus of the present invention can also be applied to a bare die module. Likewise, in lieu of being applied to C4 solder joints, such as C4 solder joints 175 shown in FIG. 3, the methods and apparatus of the present invention can also be applied to protect other types of connections from corrosion caused by corrosion inducing components such as moisture, carbon dioxide and octanoic acid. Thus, while the present invention has been particularly shown and described with reference to the preferred embodiments thereof, it will be understood by those skilled in the art that these and other changes in form and detail may be made therein without departing from the spirit and scope of the present invention.

What is claimed is:

1. An apparatus, comprising:
a substrate;
at least one chip electrically connected to the substrate by solder joints;
a thin cast polymer barrier layer covering the solder joints, the cast polymer barrier layer being exposed to, and protecting the solder joints from, a gaseous environment.

2. The apparatus as recited in claim 1, wherein the cast polymer barrier layer is thermally stable at least to the reflow temperature of the solder joints and has a decomposition temperature below that of the substrate.

3. The apparatus as recited in claim 2, wherein the cast polymer barrier layer has a melting point above the reflow temperature of the solder joints.

4. The apparatus as recited in claim 1, wherein the solder joints are controlled collapse chip connection (C4) solder joints comprising Pb-containing solder balls, and wherein the gaseous environment includes at least one of moisture, carbon dioxide and octanoic acid.

5. The apparatus as recited in claim 1, wherein the gaseous environment includes at least one of moisture, carbon dioxide and octanoic acid.

6. The apparatus as recited in claim 1, wherein the cast polymer barrier layer is selected from a group consisting of polystyrene; poly(oxymethyleneoxyethylene); poly(oxybutylethylene); poly(vinylidene chloride); poly(perfluoro-4-chloro-1,6-heptadiene); poly(methacrylic acid), ethyl ester; poly(methacrylic acid), n-propyl ester; poly(methacrylic acid), i-propyl ester; poly(methacrylic acid), n-butyl ester; poly(methacrylic acid), i-butyl ester; poly(methacrylic acid), sec-butyl ester; poly(methacrylic acid), n-amyl ester; poly(methacrylic acid), i-amyl ester; poly(methacrylic acid), 1,2-dimethylpropyl ester; poly(methacrylic acid), neopentyl ester; poly(methacrylic acid), 3,3-dimethylbutyl ester; poly(methacrylic acid), 1,3-dimethylbutyl ester; poly(perfluoropropylene); poly(vinyl alcohol); poly(vinyl butyrate); poly(methyl isopropenyl ketone); and combinations thereof.

7. The apparatus as recited in claim 6, wherein the cast polymer barrier layer includes a residual amount of a solvent including at least one of toluene, xylene, cyclohexane, nitrobenzene, dioxane, methyl ethyl ketone, a glycol, glycerol, an alcohol, and tetrahydrofuran.

8. A chip module apparatus, comprising:
a module substrate;
at least one chip electrically connected to the module substrate by controlled collapse chip connection (C4) solder joints, the at least one chip being enclosed within a cavity that includes a gaseous environment;
a thin cast polymer barrier layer covering the C4 solder joints, the cast polymer barrier layer being exposed to, and protecting the C4 solder joints from, the gaseous environment within the cavity.

9. The chip module apparatus as recited in claim 8, wherein the cast polymer barrier layer is thermally stable at least to the reflow temperature of the C4 solder joints and has a decomposition temperature below that of the module substrate, and wherein the cast polymer barrier layer has a melting point above the reflow temperature of the C4 solder joints.

10. The chip module apparatus as recited in claim 8, wherein the gaseous environment within the cavity includes at least one of moisture and carbon dioxide that enters the cavity from outside the cavity.

11. The chip module apparatus as recited in claim 8, wherein the chip module assembly includes a cap that defines a portion of the cavity, and wherein the gaseous environment within the cavity includes octanoic acid outgassed from a thermal grease disposed in the cavity between the at least one chip and the cap.

12. The chip module apparatus as recited in claim 8, wherein the cast polymer barrier layer is selected from a group consisting of polystyrene; poly(oxymethyleneoxyethylene); poly(oxybutylethylene); poly(vinylidene chloride); poly(perfluoro-4-chloro-1,6-heptadiene); poly(methacrylic acid), ethyl ester; poly(methacrylic acid), n-propyl ester; poly(methacrylic acid), i-propyl ester; poly(methacrylic acid), n-butyl ester; poly(methacrylic acid), i-butyl ester; poly(methacrylic acid), sec-butyl ester; poly(methacrylic acid), n-amyl ester; poly(methacrylic acid), i-amyl ester; poly(methacrylic acid), 1,2-dimethylpropyl ester; poly(methacrylic acid), neopentyl ester; poly(methacrylic acid), 3,3-dimethylbutyl ester; poly(methacrylic acid), 1,3-dimethylbutyl ester; poly(perfluoropropylene); poly(vinyl alcohol); poly(vinyl butyrate); poly(methyl isopropenyl ketone); and combinations thereof.

13. The chip module apparatus as recited in claim 8, wherein the cast polymer barrier layer includes a residual amount of a solvent including at least one of toluene, xylene, cyclohexane, nitrobenzene, dioxane, methyl ethyl ketone, a glycol, glycerol, an alcohol, and tetrahydrofuran.

14. A method for producing an apparatus, comprising the steps of:
providing a chip assembly comprising at least one chip electrically connected to a substrate by controlled collapse chip connection (C4) solder joints;
covering the C4 solder joints with a thin cast polymer barrier layer cast from a polymer solution.

15. The method as recited in claim 14, wherein the step of covering the C4 solder joints includes the steps of:
wicking the polymer solution into a gap between the at least one chip and the substrate, wherein the C4 solder joints are disposed in the gap, and wherein the polymer solution comprises polymer in a solvent;
vacuum stripping the solvent from the polymer solution wicked into the gap to provide the cast polymer barrier layer on the C4 solder joints.

16. The method as recited in claim 15, wherein the polymer solution comprises
polymer selected from a group consisting of polystyrene; poly(oxymethyleneoxyethylene); poly(oxybutylethylene); poly(vinylidene chloride); poly(perfluoro-4-chloro-1,6-heptadiene); poly(methacrylic acid), ethyl ester; poly(methacrylic acid), n-propyl ester; poly(methacrylic acid), i-propyl ester; poly(methacrylic acid), n-butyl ester; poly(methacrylic acid), i-butyl ester; poly(methacrylic acid), sec-butyl ester; poly(methacrylic acid), n-amyl ester; poly(methacrylic acid), i-amyl ester; poly(methacrylic acid), 1,2-dimethylpropyl ester; poly(methacrylic acid), neopentyl ester; poly(methacrylic acid), 3,3-dimethylbutyl ester; poly(methacrylic acid), 1,3-dimethylbutyl ester; poly(perfluoropropylene); poly(vinyl alcohol); poly(vinyl butyrate); poly(methyl isopropenyl ketone); and combinations thereof; and
solvent selected from a group consisting of toluene, xylene, cyclohexane, nitrobenzene, dioxane, methyl ethyl ketone, a glycol, glycerol, an alcohol, and tetrahydrofuran, and combinations thereof.

17. A method for reworking a chip module, comprising the steps of:
providing a chip assembly comprising at least one chip electrically connected to a substrate by controlled collapse chip connection (C4) solder joints, wherein the C4 solder joints are covered with a thin cast polymer barrier layer;
reflowing the C4 solder joints and melting or at least partially decomposing the cast polymer barrier layer, wherein the cast polymer barrier layer is thermally stable at least to the reflow temperature of the C4 solder joints and has a decomposition temperature below that of the substrate, and wherein the cast polymer barrier layer has a melting point above the reflow temperature of the C4 solder joints;
removing the at least one chip from the substrate while the C4 solder joints are in a reflowed state;
preparing one or more removal sites on the substrate where the at least one chip was removed.

18. The method as recited in claim 17, wherein the cast polymer barrier layer is selected from a group consisting of polystyrene; poly(oxymethyleneoxyethylene); poly(oxybutylethylene); poly(vinylidene chloride); poly(perfluoro-4-chloro-1,6-heptadiene); poly(methacrylic acid), ethyl ester; poly(methacrylic acid), n-propyl ester; poly(methacrylic acid), i-propyl ester; poly(methacrylic acid), n-butyl ester; poly(methacrylic acid), i-butyl ester; poly(methacrylic acid), sec-butyl ester; poly(methacrylic acid), n-amyl ester; poly(methacrylic acid), i-amyl ester; poly(methacrylic acid), 1,2-dimethylpropyl ester; poly(methacrylic acid), neopentyl ester; poly(methacrylic acid), 3,3-dimethylbutyl ester; poly(methacrylic acid), 1,3-dimethylbutyl ester; poly(perfluoropropylene); poly(vinyl alcohol); poly(vinyl butyrate); poly(methyl isopropenyl ketone); and combinations thereof.

19. The method as recited in claim 17, wherein the step of preparing the substrate includes the steps of:
heating the substrate to decompose any remaining portion of the cast polymer barrier layer;
dressing the one or more removal sites with a tinned sintered porous Cu block.

20. The method as recited in claim 19, further comprising the steps of:
electrically connecting at least one replacement chip to the substrate at the one or more removal sites using replacement C4 solder joints;
covering the replacement C4 solder joints with a replacement thin cast polymer barrier layer.

21. The method as recited in claim 20, wherein the step of covering the replacement C4 solder joints with a replacement thin cast polymer barrier layer comprises the steps of:
wicking a polymer solution into a gap between the at least one replacement chip and the substrate, wherein the replacement C4 solder joints are disposed in the gap, and wherein the polymer solution comprises polymer in a solvent;
vacuum stripping the solvent from the polymer solution wicked into the gap to provide the replacement cast polymer barrier layer on the replacement C4 solder joints;
wherein the polymer solution comprises
polymer selected from a group consisting of polystyrene; poly(oxymethyleneoxyethylene); poly(oxybutylethylene); poly(vinylidene chloride); poly(perfluoro-4-chloro-1,6-heptadiene); poly(methacrylic acid), ethyl ester; poly(methacrylic acid), n-propyl ester; poly(methacrylic acid), i-propyl ester; poly(methacrylic acid), n-butyl ester; poly(methacrylic acid), i-butyl ester; poly(methacrylic acid), sec-butyl ester; poly(methacrylic acid), n-amyl ester; poly(methacrylic acid), i-amyl ester; poly(methacrylic acid), 1,2-dimethylpropyl ester; poly(methacrylic acid), neopentyl ester; poly(methacrylic acid), 3,3-dimethylbutyl ester; poly(methacrylic acid), 1,3-dimethylbutyl ester; poly(perfluoropropylene); poly(vinyl alcohol); poly(vinyl butyrate); poly(methyl isopropenyl ketone); and combinations thereof; and
solvent selected from a group consisting of toluene, xylene, cyclohexane, nitrobenzene, dioxane, methyl ethyl ketone, a glycol, glycerol, an alcohol, and tetrahydrofuran, and combinations thereof.
